(19) United States
(12) Patent Application Publication
(10) Pub. No.: US 2024/0403796 A1
(43) Pub. Date: Dec. 5, 2024

(54) AUTONOMOUS PROBLEM DISCOVERY, MODELING, PREDICTION, AND RESOLUTION IN A LOGISTICS ENVIRONMENT

(71) Applicant: Tahir Ahmed, Naperville, IL (US)

(72) Inventors: Tahir Ahmed, Naperville, IL (US); Qudsia Ahmed, Naperville, IL (US)

(73) Assignee: Fynite Corp., Warrenville, IL (US)

(21) Appl. No.: 18/203,315

(22) Filed: May 30, 2023

(51) Int. Cl. G06Q 10/067; G06Q 10/0639; G06Q 10/08

(52) U.S. Cl. CPC G06Q 10/067; G06Q 10/06393; G06Q 10/08

(57) ABSTRACT

A system for autonomously observing and improving logistics processes is provided. The system comprises a computer and application executing thereon that presents a list of metrics for a first logistics process and receives selection of a first metric from the list. The system also suggests dependencies of the first metric, the dependencies comprising factors bearing on performance of the first logistic process. The system also receives selection of a first dependency and a dependency metric associated with the first dependency. The system also receives specific demarcation points for the first metric associated with potentially anomalous behavior. The system also implements a watch of the first metric comprising periodic calculation of the first metric. The system issues a trigger upon a first calculation of the first metric falling outside of at least one specified demarcation point, the first calculation suggesting an anomaly.

### CROSS REFERENCE TO RELATED APPLICATIONS

None

### FIELD OF THE DISCLOSURE

The present disclosure is in the field of logistics. More particularly, the present disclosure provides systems and methods of capturing metrics associated with a logistics processes, training a machine learning model to proactively analyze the metrics, predict degradations, and make suggestions, and providing the model's output to enterprise resource planning systems for creation of new business rules adjustment of existing business rules. Further, a method is provided to automate the database integration process using a ML model and a standard dictionary of table fields.

### BACKGROUND

Logistics is a component of supply chain management that deals with the efficient forward and reverse flow of goods, services, and related information from the point of origin to the point of consumption according to the needs of customers. Logistics management is a component that holds a supply chain together. Resources managed in logistics may include tangible goods such as materials, equipment, and supplies, as well as food and other consumable items.

Logistics deals with the acquisition, movement, and storage of raw materials, semi-finished goods, and finished goods. For organizations that provide services such as general merchandise, grocery, mail deliveries, public utilities, and post-sale services, logistical problems also need to be addressed.

Logistics further deals with movements of materials or products from one facility to another, for example from production facility to assembly plants to distribution centers. Logistics generally does not deal with the material flow within the production or assembly plants, for example production planning or single-machine scheduling.

Logistics occupies a significant amount of the operational cost of an organization or country. The complexity of logistics can be modeled, analyzed, visualized, and optimized and automated by dedicated simulation software. The minimization of the use of resources is a common motivation in all logistics fields.

### BRIEF DESCRIPTION OF THE FIGURES

FIG. 1 is a block diagram of a system of autonomous problem discovery, tracking, modeling, prediction, and resolution in a logistics environment according to an embodiment of the present disclosure.

FIG. 2 shows the parent-child relationship for all metrics that are tracked along with accountability components in a nested flow.

FIG. 3 is a more detailed architecture of the autonomous workings of the model.

FIG. 4 shows a dictionary of standard fields that is used to establish a standard interface between the primary databases and any system integrating with these databases.

FIG. 5 shows a method that automates the connectivity or integration between a Primary database and adjacent systems such as the autonomous system of FIG. 3.

### DETAILED DESCRIPTION

Systems and methods described herein track at least one pre-defined or user-entered metric describing a logistics process based on predefined or user-entered rules and train a machine learning (ML) model to recognize anomalies in the metric's behavior, predict degradations of the process based at least on the recognized anomalies, and suggest proactive measures to prevent actual degradations or even failures. The system promotes enterprise resource planning (ERP) systems to receive output from the ML model to facilitate automation of logistics and business processes including execution of business rules. The system executes these operations autonomously such that the logistics operations are not burdened or intruded upon or otherwise affected by allowing user to set triggers and take actions outside of the ERP system such as creating tickets, sending follow up emails, and escalating issues.

One benefit of systems and methods provided herein is reusability: the traditional approach is to create calculation fields each time a measurement tracking is required. The current framework allows for the re-usability of the metrics and dependencies where complete performance tracking can be enabled with one user touch. For example, one of the key supply chain metrics for suppliers and DCs is On-Time-In-Full (OTIF) meaning on-time delivery of all goods and full quantity on the order. If the metric is underperforming the accountability is divided between sourcing DC (supplier), transportation (carrier), destination distribution center (DC) (usually business), and other (weather, traffic, etc.). The framework allows business users to enable the metric along with all accountabilities (supplier, carrier, business, other) with one touch and reuse multiple times without the need to create another calculation. Thereby, reducing the dependency on expensive data science and data analytics resources.

Another benefit of the above framework is that it allows the user to define and automate rules (corrective actions) when metric or accountability degradation occurs. The measured metric/accountability data and rules information is then used to train the ML component of the AI to suggest and automate the corrective actions. The AI further uses this information to suggest and apply similar corrections on extended or similar domains. For example, if a rule is set for one particular supplier DC and the metric improves as a result of the rule application, the AI will suggest applying the same rule to all DCs in the region or other DCs being similar to the operations of the said DC, thereby reducing the business operations burden. Traditionally, this is achieved through a business rule change on a case-by-case basis requiring operations to review the degradation on a daily or weekly basis and taking manual actions to change the business rules in the ERP system.

Yet another and highly value-add benefit of the above framework is the training data for the ML component of the Al. The framework makes it possible to auto-engineer the features and labels for training the ML model. When a user sets rules on the relevant data, it enables the ML model to know what the user considers “success” or “failure”—these are the labeling of the data for training. The internal and external data along with the domain, specified by the user such as metrics, accountabilities, carriers, or distribution centers tell the ML model the inputs to consider-these are the features of the data. Traditionally, a data scientist needs to run such analysis for the implementation of ML capabilities. However, the provided approach makes it possible for any business user to define the training data, effectively reducing the need for expensive data science resources.

Systems and methods provide a mechanism for users to track metrics specific to their respective industry along with accountabilities using a parent-child nested flow between metrics and allow users to define triggers and actions (i.e. when any given metric is degraded) to take actions. Systems and methods allow the ML model to use historical and real-time internal client and external world data in correlation with tracked metrics and rules to get trained and predict anomalies and suggest or take action automatically reducing business risk and improving efficiency. Systems and methods provide a mechanism for this autonomous system or any other adjacent system to integrate with the primary (client) database using a standardized dictionary and a trained ML model that predicts the mapping of every primary database element to a standard field in the dictionary. This approach significantly reduced the integration effort and time by automating the processes.

The system allows for a framework to connect existing client systems with the AI without interruption to business transactions. It provides a method to define the tracking of KPIs and their dependencies, a method for business operations to define corrective rules, and a method to harness event, metric, and rules data for the training of the ML component of the AI. The trained ML model automates business decision-making, driving the autonomous supply chain. It enhances forecasts of future failures and enables operations managers to build business cases for enhancements based on factual data. The system uses both internal and external data sources to train the ML component of the AI. Examples of the external data sources include weather, traffic, events and financial data. The system provides a framework to complement the existing ERP systems customers have by augmenting the additional rules needed to course correct metric degradations and operational anomalies without requiring the clients to change the entire system.

Systems provided herein allow current business ERP systems and external data sources to connect to the trained ML model that observes and monitors logistics and business processes and flows. The ML model executes these tasks in an automated manner to learn and facilitate automation of business processes and autonomisation. Systems provided herein use various subsystems that work in tandem.

While systems and methods provided herein are directed to the field of logistics the application of systems and methods is not limited to logistics. For example, a user can automate the discovery and resolution of problems using this method in the medical industry, or finance industry. Similarly, the suggestive integration method is applicable to many industries, not just logistics.

The ML model, once trained, may predict impact of degradations of logistics processes and may suggest creation of new business rules or subject logistics process may depend on preceding or parent processes further upstream from the subject process. Metrics associated with those dependencies may be examined by the ML model in conjunction with the primary metric of the subject process. Root cause analysis is facilitated when analysis of an anomalous situation in a first area leads to a second area that is determined to be the actual source of the problem manifesting itself in the first area. The ML model may be trained to perform simulations and sensitivity analysis when numerous variables are fed to the model to determine a problem source when such source is otherwise difficult to pinpoint.

An example of parent and child processes is as follows: On-time-in-full is a parent metric that has on-time, and in-full as a child metric. The amount of the goods delivered is tracked through the ‘in-full’ (child) metric. This metric also has further child metrics. If the in-full metric is less than 100%, a user should be able to review the accountable parties under this metric. The loss can come from the supplier not shipping the full quantity (child metric), the carrier not loading or losing part of the inventory (child metric), or the receiver, the merchant not accounting for the received inventory (child metric). Hence, each of the child metrics allows the system to drill down into the root causes and get to the bottom of the issue as opposed to just presenting the problem via the parent metric.

The framework for metrics, as illustrated in the figures, is nested with parent-child relation. Each child is essentially another metric that represents an accountability measure for the parent metric.

A user of the system may be concerned about a logistics problem in his/her business, for example on-time delivery of products to the final customer. The user may identify a metric associated with on-time delivery. Alternatively, the system may provide a list of metrics from which the user may choose. The user may define measurements and specify demarcation points for the metric. The system may provide standard accountability definitions for the metric to assist the user.

The system then runs calculations on the metric on a periodic basis. The system feeds the results of the calculations to the ML model to detect anomalies in the data, predict degradation, and make suggestions that may be passed to ERP systems. The ML model effectively learns based on processing metric data many times and based on the learning detects degradations and makes suggestions that at least the user and others, for example ERP users, can analyze and consider.

As noted, the system also provides for key dependencies of the subject process or metric to be measured and examined by the ML model. The ML model may then attempt to link or associate behavior of one or more of the dependency metrics to the subject metric to explain an observed or reported problem with the process measured by the subject metric. In the example of on-time delivery being the metric of interest, a supplier, a carrier, and retailers may be dependencies such that the behavior of the on-time delivery metric is affected by at least one of these dependencies. The performance of parties from those three groups may be considered by the ML model while seeking to identify a source or sources of anomalous behavior, degradation, or outright failure.

The ML model, once trained, may have the ability to consider hypothetical situations involving multiple variables and perform sensitivity analysis by manipulating one or more variables and observing the results. In a logistics setting, primarily human factors can affect an aspect of performance such as incoming delivery promptness, inventory shrinkage, inventory turnover, customer returns, and labor costs. In addition to human factors, factors such as weather, traffic problems, major highway construction, and regulations can affect logistics operations. These non-human factors can be considered via creation of metrics that can be included in algorithms or formulae that the AI system can be provided or developed on its own.

A logistics problem that is difficult to solve may be related to factors that are not obvious or easily discernible. Once data has been determined to be good, i.e., reliable, the data can be used multiple times in algorithms that may be found to be useful and even critical. Once trained, the ML model may be relied upon to handle real and hypothetical scenarios. In a multi-variable situation, a retailer with numerous distribution centers may be able to determine the root cause of a problem.

The framework may provide a means to input arbitrary parameter values as inputs to the trained machine learning model and run predictions, sensitivity analysis, modeling and hypothesis testing. As the framework allows for defining and calculating accountabilities for each metric, it is possible to identify the party responsible for accountability for degradations or outright failures. With such analysis, a logistics department of a large company may ultimately determine that one trucking company is better than another. As such, it may decide to use one category of carriers for a portion of goods transport and another category of carriers or private fleet for the remainder of goods transport.

The framework provided by the trained ML model enables users to define data, set rules, identify what constitutes reliable or “good” data, and identify the parties who own accountability for failures. With assisted learning from the business operations (metrics, rules and actions) and the observance of the metric performance, the ML model continues to learn and produces steadily more reliable output including actionable recommendations that may be transmitted to business operations, vendors, carriers, merchants, and third parties.

The ML model also feeds into a learned language model (LLM) to facilitate a conversation with a business user. The accuracy and precision of metrics makes the LLM more objective, complete, and accurate. The LLM may be a bot and may assist with business insights, recommended actions and root cause analysis based on the approach that all metrics have at least a parent metric relationship and a child metric relationship, assuring that accountability remains in place.

The system further trains the ML model to simulate logistics scenarios prior to implementation and perform sensitivity analysis using at least dependency metrics of multiple dependencies to identify sources of potential anomalies and failures associated with the first logistics process. When these actions are taken after incidents occur, it may lead to comprehensive root cause analysis with accountabilities. The ML models can also be used to predict what will fail in future based on the current data (making it predictive and suggestive).

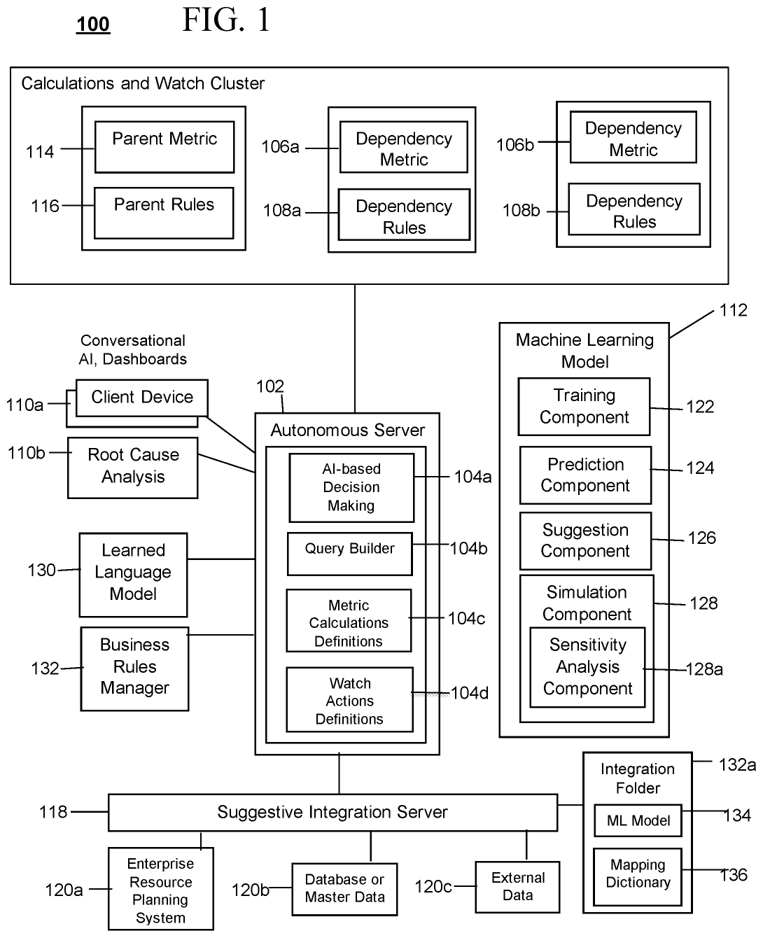

Turning to the figures, FIG. 1 is a block diagram of a system of autonomous improvement of logistics infrastructures according to an embodiment of the present disclosure. FIG. 1 depicts components and interactions of a system 100 of autonomous problem discovery, tracking, modeling, prediction, and resolution in a logistics environment in accordance with an embodiment of the present disclosure. System 100 comprises an autonomous server 102, referred to hereafter as the server 102.

System 100 also comprises an Al-based Decision Making module 104a, a Query Builder 104b, Metric Calculations Definitions 104c, and Watch Actions Definitions 104d, each one of which executes at least partially on the server 102

System 100 also comprises Dependency Metrics 106a-b, Dependency Rules 108a-b, client device 110a and Root Cause Analysis 110b.

System 100 also comprises components of the ML model 112 comprising a processing component 122, a prediction component 124, a suggestion component 126, a simulation component 128, a sensitivity analysis component 128a which is provided as a subcomponent of the simulation component 128, a learned language model 130, and a business rules manager 132.

The server 102 is at least one computer system located at a single or multiple geographic locations. Multiple software modules or applications executing on the server 102 and elsewhere in some embodiments comprise at least the AI-based Decision Making module 104a, a Query Builder 104b, Metric Calculations Definitions 104c, and Watch Actions Definitions 104d. These modules handle much of the functionality described herein comprising presenting choices to users about what logistics processes that may be of interest to them and what metrics they may wish to track. The server 102 also arranges and executes the periodic calculations of metrics and feeds the calculations to the ML model 112. Training components train the ML model 112 as described above.

The client devices 110a are computers and software used by users in contacting the server 102 to request the services provided herein. The ML model 112 is described at length above and handles processing of calculations of metrics, identification of real or potential degradations, making of predictions and suggestions, and conducting simulations which may include performing sensitivity analysis.

The system 100 also comprises parent metrics 114 and parent rules 116. The parent metrics 114 may represent processes upon which subject logistics processes depend. The ML model 112 may examine the performance of the parent metrics 114 in detail in attempting to determine why the system is having problems that may be evidenced by anomalous behavior of the parent or child metrics.

The suggestive integration server 118 allows the server 102 to connect to ERP systems 120a. Examples of ERP systems 120a comprise order management systems (OMS), warehouse management systems (WMS), transportation management systems (TMS), retail management systems (RMS), and last mile distribution systems (LMD). Examples of internal data comprise data from master data management or data lake within the organization. Examples of external data systems comprise weather, traffic and events data.

The suggestive integration server 118 enables the server 102 to connect to Database or Master Data 120b and External Data 120c. The suggestive integration server 118 also enables connection to an integration folder 132a which contains an ML Model 134 and a Mapping Dictionary 136.

The processing component 122 of the ML model 112 uses the calculated data describing metrics that are captured by the server 102 for training of the ML model. The processing component 122 may identify possible or actual degradations. The prediction component 124 of the ML model 112 generates predictions based on output of the processing component 104a and the suggestion component 126 generates suggestions based on the output of the prediction component 124.

The simulation component 128 may model various structures and scenarios that may be at least partly hypothetical and involve multiple variables. A user, via the client device 110a can request the ML model 112 to create various test scenarios involving various inputs to run tests to locate a component or actor in the overall system 100 that is aberrant. ML models may be used to assess business rule changes and scenarios-modeling leading to lower failure risk and increased success rate.

The sensitivity analysis component 128a may be used to manipulate one or more components in various manners to determine the effect of such manipulation on the overall system 100. Running multiple iterations using the sensitivity analysis component 128a may allow a failing or aberrant component to be identified and isolated and potentially altered, if necessary, when the ML model 112 concludes that the aberrant component is the true source of the subject opportunity.

The actions and the output of the ML model 112 and its components are closely observed by the server 102 as it is the function of at least components of the server 102 to oversee and improve the quality of the actions of the ML model 112. As the ML model 112 may be processing many variables at a time in simulations conducted by the simulation component 128, the server 102 regulates such simulations to assure that erroneous conclusions are not made which could lead to adverse actions and results that exacerbate problems.

The learned language model 130 fetches information on demand, performs root cause analysis, and generates dashboards and reports. The learned language model 130 also takes commands from users via at least client devices 110a, for example entering a new business rule, and may also offer general consultancy. The business rule manager 132 is used to maintain records of and manage changes to business rules configured by the ERP systems 120a.

The watch functionality may extend rules. The AI learns behavior from one domain and may suggest extension of rules. The user interactions and monitoring of the metrics let the AI understand how it can extend rules. Autonomy allows the user to define rules via watches. With autonomy, the data contains hints that allow proactive execution of business rules or creation of new rules.

The ML model is used to predict the outcome as the input parameters change. For example, if the delivery window is increased for carriers, what will be the impact on the on-time performance. If the delivery window is increased, and a distribution center has capacity to handle the traffic, the model will predict good results. On the other hand if the delivery window is increased and the distribution center has limited capacity on added days, the model will predict bad results. The simulation enables businesses to know what will and will not work without using actual transactions as a test bed and impacting performance.

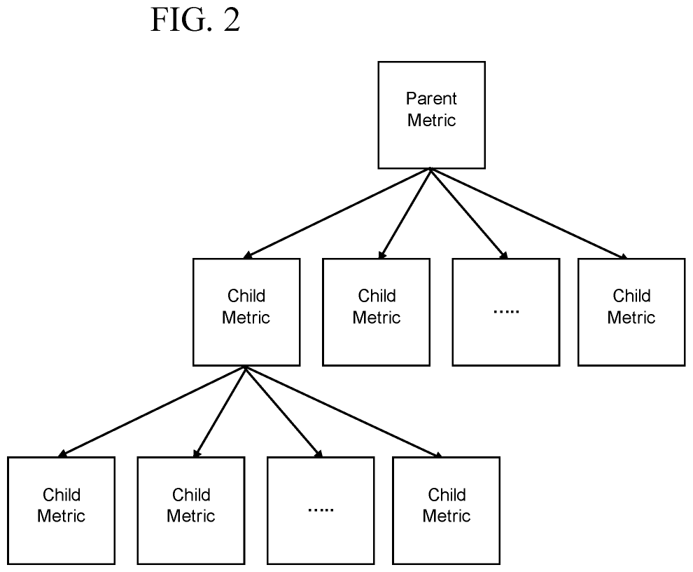

FIG. 2 is an illustration of relationships between metrics. Generally, a metric of interest has dependencies or parent metrics wherein the behavior of the subject metric of interest is influenced by or depends at least in part on the behavior of the parent metric. The metric of interest in FIG. 2 may be one of the child metrics. Many metrics will have both parent metrics and child metrics of their own.

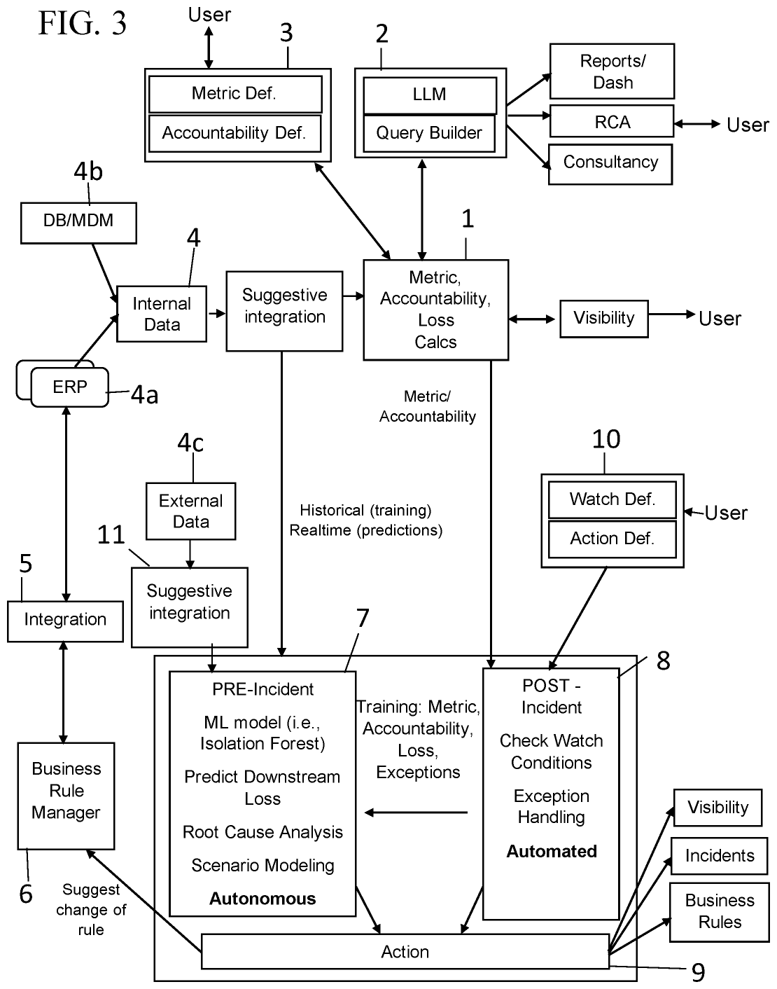

FIG. 3 is a diagram of a system of autonomous improvement of logistics infrastructures according to an embodiment of the present disclosure. FIG. 3 is a logical diagram. Objects depicted in FIG. 3 do not necessarily correspond to components of the system 100 depicted in FIG. 1. While each circle or bubble in FIG. 3 is numbered, numbering of such bubbles does not indicate a chronological or operational order.

In FIG. 3, a system is provided that allows a user to select from an existing list of metrics or input a metric definition for a logistics process or objective. The metric is run at a predetermined frequency along with metrics associated with key dependencies of the logistics process. The system promotes users to define measurements for accountabilities and specify demarcation points for calculations. The system provides standard metric and accountability definitions to users based on the user's industry to expedite the initial configuration of the system.

As business users set rules to respond to triggers based on the metric degradation, the ML model is trained using this data to automate the behavior. At a certain point in time, the system has sufficient learning to handle scenarios similar to the rules the user has set. For example, if a rule is set to tender the load to secondary carriers for one distribution center (DC), i.e. DC 6070, and if the rule implementation improves the on-time metrics for the said DC, the system may suggest to business operations to have a similar rule in place for all similar DCs and thereby drive the suggestive behavior. In a completely autonomous mode, the system will make this decision and only inform the business operations.

A subsystem (1) runs metric calculations in accordance with the specified frequency using a Calculation server cluster. A subsystem comprising (8), (9), and (10) allows the user to specify metric goals and actions to be taken when a violation occurs using a Rule-Action server cluster. Such actions may comprise supplier performance ratings, business rules changes, alerting, temporary and permanent changes to sourcing decisions, and starting and stopping services from newer clients.

Historical and real-time data on performance of metrics and actions is periodically passed to the ML model (7) for training. Once trained, the ML model (7) predicts degradation of metrics defined by business users using internal data (4) and external data (4c). The ML model (7) predicts impact and suggests applicable actions. Actions are suggested in advance as proactive actions (7) in contrast to rule-based actions at (8). The system also tracks rule exceptions (8) and passes the data to ML model (7) for training. The system further provides a learned language model (2) interface to, as discussed above with FIG. 1, fetch information on demand, perform root cause analysis, and generates dashboards and reports. The learned language model (2) also takes commands from users, for example entering a new business rule, and may also offer general consultancy.

A conversation AI component is a bot that responds to user prompts by parsing the prompt into intents and entities. Using intent and entity information, an SQL query is generated to pull or modify the relevant information in the database. This mechanism is supported by a query builder algorithm that finds the most efficient query joining multiple tables for accessing the requested information.

The system uses an integration layer (5) to connect with ERP systems such as order management systems (OMS), warehouse management systems (WMS), transportation management systems (TMS), retail management systems (RMS), and last mile distribution systems (LMD), internal data sources such as master data management and external data sources such as weather, traffic, and geographical/economical events. A business rule manager (6) maintains records of and manages changes to business rules set by ERP systems and others.

Systems and methods provided herein may use existing ERP systems and may provide methods to incentivize users to use the system to automate their tasks through metric, accountability, rules, and actions. Methods are provided to request on-demand information through calculated metrics. Methods are provided to pass metric, accountability, rule, and action information, both historical and real-time, to the ML model for training and predictions. Methods are provided to execute business rules in automated manners. Methods are further provided to execute business rules in autonomous manners using internal and external information.

Users are provided with standard metric-accountabilities templates. These templates contain all industry standard metrics, accountabilities and respective calculations allowing users to re-use as opposed to creating a new metric for each use case.

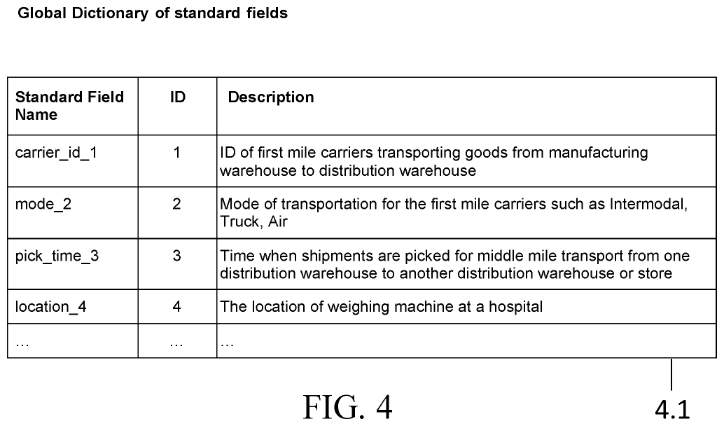

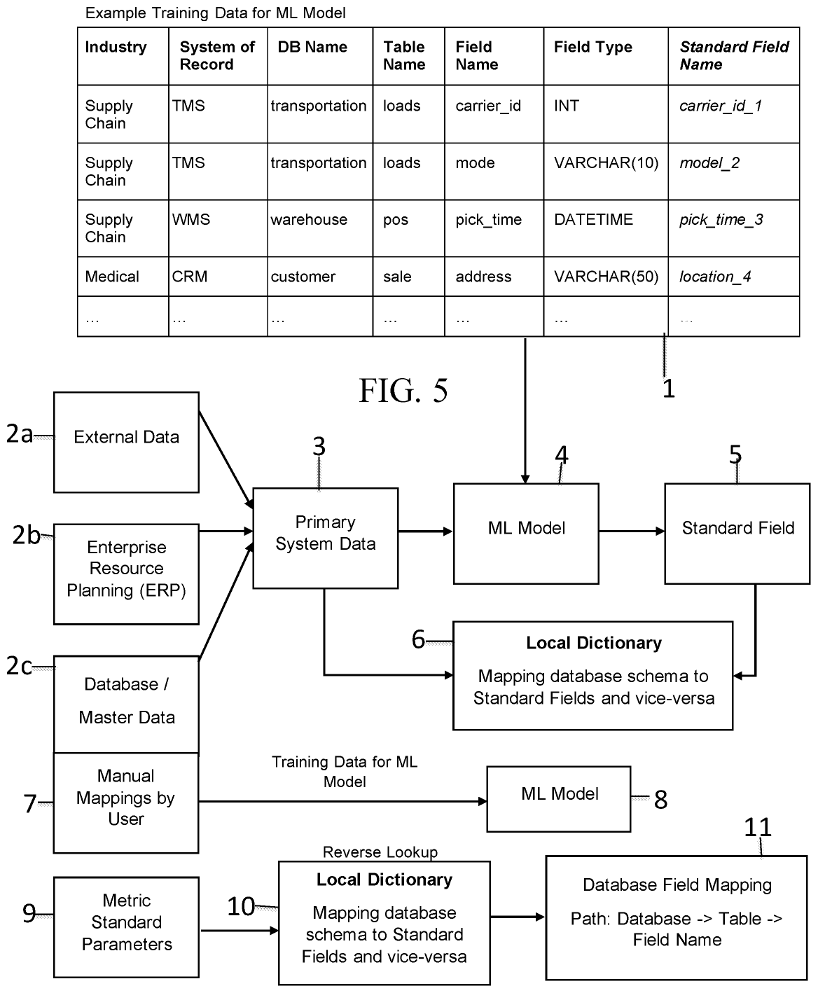

Frameworks provided herein use methods partially depicted in FIG. 5 to automate a high percentage of the integration of the autonomous server with the client's data and external data. FIG. 5 identifies the data headers of the ERP systems, master data and external data sources using an ML model and a dictionary. The working of methods partially depicted in FIG. 5 is as follows. A dictionary is used with unique table fields assigned to commonly measured data in supply chain or any other industry such as the medical industry. As shown in FIG. 5, a training data set (1) is prepared with features containing the meta data such as industry, system of record, names of database, name of table, table field and field type as inputs. Each row of this data is labeled with a standard field name of a global dictionary shown in FIG. 4. This dataset is used to train an ML model (4) along with any manual mappings (7) done by the user. Once trained, the ML model (4) predicts the standard table field label for any arbitrary database given its meta data. After the mapping to standard table fields is achieved, a local dictionary (6) is prepared containing the mapping of every element of client data (3) to a standard label in the global field name dictionary (4.1 in FIG. 4). This allows for a reverse lookup to identify the full path to the data element in the client database given a standard label. FIG. 5 uses local dictionary (10) to match the standard parameters in the metrics to specific client database elements (11). This approach automates the core of integration efforts to map client databases to any system using a standardization approach and a trained ML mode. The automation of data identification leads to faster integration with upstream or downstream systems significantly reducing the time to connect any system with a client environment. As with any ML system the accuracy of the integration is based on the completeness and accuracy of the training data and may contain a small percentage of error. Such errors can be mitigated by providing the end users a suggestion to the best prediction and prompting for a confirmation.

A first approach is to match column header name and suggest. A second approach is to analyze column data and suggest. The second approach also includes studying the data to find the relevance with the standard template headers. To elaborate on this, if carrier id is sought to be connected to the right internal database table field, the system will conduct a search on standard data that falls under the carrier_id. For example, a well-known American trucking carrier uses SCAC code HJBT. The system will conduct a search for the column in db containing HJBT and similar codes and mark that column as a matched suggestion for carrier_id.

A third approach is to look for data relationships and suggest. For example, it is known that the lead time is a constant and is between the order time and ship time. Therefore, if a column has a date x and another column has date y and y-x is mostly a positive constant, it is likely that x is order date and y is ship date. The final selection is the decision of the user, but the system can use this approach to make it easier for suggestions.

In an embodiment, a system for autonomously observing and improving logistics processes is provided. The system comprises a computer and application executing thereon that presents a list of metrics for a first logistics process and receives selection of a first metric from the list. The system also suggests dependencies of the first metric, the dependencies comprising factors bearing on performance of the first logistic process. The system also receives selection of a first dependency and a dependency metric associated with the first dependency. The system also receives specific demarcation points for the first metric associated with potentially anomalous behavior. The system also implements a watch of the first metric comprising periodic calculation of the first metric.

The system issues a trigger upon a first calculation of the first metric falling outside of at least one specified demarcation point, the first calculation suggesting an anomaly. Upon completing the first calculation, the system examines at least the dependency metrics to identify a source of the first metric falling outside of at least one specified demarcation point and assert a trigger.

The system implements methods used for anomaly detection comprising machine learning, rules, and statistical analysis. The system trains a machine learning model to process periodic calculations of at least the first metric and predict degradation of the first logistics process and wherein training data comprises ERP data, internal data and external data and measurements data based on metric-accountabilities and rules-actions.

The system further trains the model to proactively provide suggestions to address predicted degradations. The system further trains the model to simulate logistics scenarios prior to implementation and perform sensitivity analysis using at least dependency metrics of multiple dependencies to identify sources of potential anomalies and failures associated with the first logistics process.

The system provides an integration layer to connect with enterprise resource planning (ERP) systems, master internal data and external data and further provides a business rule manager to maintain records and manage changes to business rules set by the ERP systems. The system is autonomous such that the system requires no changes to business processes of a user and further functions independently of the operations of the user.

In another embodiment, a method is provided for autonomously improving performance of a logistics process. The method comprises a computer receiving a first plurality of measurements of a first metric associated with a first logistics process, the plurality captured during at least a first time period. The method also comprises the computer providing the first plurality to a machine learning model. The method also comprises the computer training the model to recognize potentially anomalous behaviors of the first metric from at least analysis of the first plurality. The method also comprises the computer training the model to examine dependencies of the first metric. The method also comprises the computer training the model to predict degradations based at least on one of recognized anomalous behaviors and the examined dependencies.

The method also comprises the computer, based on the training and having provided a second plurality of measurements of the first metric to the machine learning model, receiving a prediction from the model of a first degradation of service quality associated with at least the first logistics process. The method also comprises the computer receiving a predicted impact of the first degradation from the model.

The method also comprises the computer receiving suggested actions from the model to address the first degradation. The method also comprises the computer directing the machine learning model to furnish output to a learned language model (LLM) for at least performance of root cause analysis and creation and alteration of business rules. The method also comprises the computer training the model to link behaviors of the dependencies to potential problems with the first metric and the first logistics process and training the model to perform simulations and sensitivity analysis using the dependencies to identify actual and potential problems with at least the first logistics process.

In yet another embodiment, a system for autonomously improving a logistics process is provided. The system comprises a computer and an application executing thereon that passes historical and real-time metric, accountability, rule, and action information about a first logistics process to a machine learning model. The system also receives, based at least on the passed information, predictions about degradations of performance associated with the first logistics process from the model. The system also receives suggested applicable actions from the model to resolve the predicted degradations. The system also feeds the predictions and suggested actions to an enterprise resource planning (ERP) system for analysis of business rules based at least on at least the predictions and the suggested actions. The system also implements a change in business rules based on an instruction received from the ERP system based at least on the analysis.

The system further predicts table headers of data sources comprising at least one of ERP system, master data, and external data via an ML model trained on a standard or user-defined dictionary of table fields and using data source meta data comprising at least one of database name, table name and field name as features to predict a standard table field corresponding to a data source schema field, such mapping promoting preparation of a local dictionary mapping of each data source element to a standard table field name, the present approach further using data source field names and data relevance to assist in suggestive process resulting in identification of corresponding table field. Prior to passing the information to the model the system trains the model to recognize anomalies in the information.

The system promotes analysis of logistics processes and execution of related business rules in an autonomous manner that does not require changes to existing business processes. The system provides output from natural language processing (NLP) systems to about the first logistics process to the model to supplement the metric, accountability, rule, and action information.

What is claimed is:

1. A system for autonomously observing and improving logistics processes, comprising:
a computer and application executing thereon that:
presents a list of metrics for a first logistics process,
receives selection of a first metric from the list,
suggests dependencies of the first metric, the dependencies comprising factors bearing on performance of the first logistic process,
receives selection of a first dependency and a dependency metric associated with the first dependency,
receives specific demarcation points for the first metric associated with potentially anomalous behavior, and
implements a watch of the first metric comprising periodic calculation of the first metric.

2. The system of claim 1, wherein the system issues a trigger upon a first calculation of the first metric falling outside of at least one specified demarcation point, the first calculation suggesting an anomaly.

3. The system of claim 1, wherein upon completing the first calculation, the system examines at least the dependency metrics to identify a source of the first metric falling outside of at least one specified demarcation point and assert a trigger.

4. The system of claim 1, wherein the system implements methods used for anomaly detection comprising machine learning, rules, and statistical analysis.

5. The system of claim 1, wherein the system trains a machine learning model to process periodic calculations of at least the first metric and predict degradation of the first logistics process and wherein training data comprises ERP data, internal data and external data and measurements data based on metric-accountabilities and rules-actions.

6. The system of claim 5, wherein the system further trains the model to proactively provide suggestions to address predicted degradations.

7. The system of claim 5, wherein the system further trains the model to simulate logistics scenarios prior to implementation and perform sensitivity analysis using at least dependency metrics of multiple dependencies to identify sources of potential anomalies and failures associated with the first logistics process.

8. The system of claim 1. wherein the system provides an integration layer to connect with enterprise resource planning (ERP) systems, master internal data and external data and further provides a business rule manager to maintain records and manage changes to business rules set by the ERP systems.

9. The system of claim 1, wherein the system is autonomous such that the system requires no changes to business processes of a user and further functions independently of the operations of the user.

10. A method for autonomously improving performance of a logistics process, comprising:
a computer receiving a first plurality of measurements of a first metric associated with a first logistics process, the plurality captured during at least a first time period;
the computer providing the first plurality to a machine learning model;
the computer training the model to recognize potentially anomalous behaviors of the first metric from at least analysis of the first plurality;
the computer training the model to examine dependencies of the first metric; and
the computer training the model to predict degradations based at least on one of recognized anomalous behaviors and the examined dependencies.

11. The method of claim 10, further comprising the computer, based on the training and having provided a second plurality of measurements of the first metric to the machine learning model, receiving a prediction from the model of a first degradation of service quality associated with at least the first logistics process.

12. The method of claim 11, further comprising the computer receiving a predicted impact of the first degradation from the model.

13. The method of claim 11, further comprising the computer receiving suggested actions from the model to address the first degradation.

14. The method of claim 11, further comprising the computer directing the machine learning model to furnish output to a learned language model (LLM) for at least performance of root cause analysis and creation and alteration of business rules.

15. The method of claim 11, further comprising the computer training the model to link behaviors of the dependencies to potential problems with the first metric and the first logistics process and training the model to perform simulations and sensitivity analysis using the dependencies to identify actual and potential problems with at least the first logistics process.

16. A system for autonomously improving a logistics process, comprising:
a computer and an application executing thereon that:
passes historical and real-time metric, accountability, rule, and action information about a first logistics process to a machine learning model,
receives, based at least on the passed information, predictions about degradations of performance associated with the first logistics process from the model,
receives suggested applicable actions from the model to resolve the predicted degradations,
feeds the predictions and suggested actions to an enterprise resource planning (ERP) system for analysis of business rules based at least on at least the predictions and the suggested actions, and
implements a change in business rules based on an instruction received from the ERP system based at least on the analysis.

17. The system of claim 16, wherein the system further predicts table headers of data sources comprising at least one of ERP system, master data, and external data via an ML model trained on a standard or user-defined dictionary of table fields and using data source meta data comprising at least one of database name, table name and field name as features to predict a standard table field corresponding to a data source schema field, such mapping promoting preparation of a local dictionary mapping of each data source element to a standard table field name, the present approach further using data source field names and data relevance to assist in suggestive process resulting in identification of corresponding table field.

18. The system of claim 16, wherein prior to passing the information to the model the system trains the model to recognize anomalies in the information.

19. The system of claim 16, wherein the system promotes analysis of logistics processes and execution of related business rules in an autonomous manner that does not require changes to existing business processes.

20. The system of claim 16, wherein the system provides output from natural language processing (NLP) systems to about the first logistics process to the model to supplement the metric, accountability, rule, and action information.
